(19) United States
(12) Patent Application Publication
(10) Pub. No.: US 2015/0302672 A1
(43) Pub. Date: Oct. 22, 2015

(54) PROCESS, SYSTEM, METHOD AND APPARATUS FOR MONITORING STATUS AND CONTROL OF EQUIPMENT

(71) Applicants: Yadvender Singh Kalsi, Eastvale, CA (US); Vivica Kalsi, Eastvale, CA (US)

(72) Inventors: Yadvender Singh Kalsi, Eastvale, CA (US); Vivica Kalsi, Eastvale, CA (US)

(21) Appl. No.: 14/572,801

(22) Filed: Dec. 17, 2014

Related U.S. Application Data
(60) Provisional application No. 61/917,935, filed on Dec. 18, 2013.

(51) Int. Cl. G07C 9/00

(52) U.S. Cl. CPC G07C 9/00007; G07C 9/00309; G07C 2009/00769; G07C 2009/00928

(57) ABSTRACT

The present invention provides am apparatus and methods for an equipment monitoring system coupled to equipment, such as a garage door opener, sprinkler system, HVAC, and other equipment amenable to remote operation. The system permits a user to operate equipment controls via a smartphone, tablet, or other networked appliance. Photography and video equipment may be incorporated to validate equipment status and operation.

### CROSS-REFERENCE TO RELATED APPLICATION

The application claims priority from U.S. Provisional Patent Application No. 61/917,935, filed on Dec. 18, 2013, the contents of which are incorporated herein by reference.

### BACKGROUND OF THE INVENTION

The present invention relates generally to remote operation of a garage door opening mechanism. Specifically, the invention relates to monitoring and alerting a user to the status of a garage door, such as if the garage door is open, opening. closed, closing, not secure, malfunctioning, or other situations. Doors may be vertical, horizontal, rolling, overhead, or otherwise situated in a useful configuration.

An automatic garage door opening system is a modern day convenience that makes one's life easier. Garage doors are rather heavy and manual opening and closing can be labor intensive and rather awkward in inclement weather. Many people have installed garage door openers to provide a safe and convenient way of controlling the opening and closing of a door without exiting their car.

An automatic garage door opening system often includes a mechanical drive system disposed within the interior of the garage and coupled with the garage door so that the mechanical drive system causes a controlled opening and closing of the garage door. A remote control or transponder may be programmed to interface with the mechanical drive system to operate the opener from a remote location, such as the interior of a nearby vehicle. Systems usually allow operation of the garage door from specified, strategic locations, such as near an entrance to the garage.

Once the garage door is shut, the mechanical drive system may keep the garage door locked. Garage door opener systems are safer, more affordable and provide more security than ever before. The obvious security provided keeps intruders out of one of the largest openings or entry points into a home, the garage. Yet for all the security features built into modern day garage door opener systems, they still have a compromising security flaw, namely the garage door will remain open if left open. This may happen under a number of different circumstances. One situation is when the homeowner may be in a hurry and could overlook closing the garage door after the homeowner leaves or enters the property. Another circumstance is that the batteries in the remote control can be weak or dead (hence not functioning properly) and the homeowner might drive away thinking that the garage door opener system has been activated to close the garage door, while in reality, it has not been and the garage door remains open.

Portable devices are increasingly used for multiple tasks that range from telephony to video and/or photographs to computing to audio and other entertainment and instructional uses. Portable devices may be used to facilitate communication, including via a communication service. Such devices may include mobile telephones, personal digital assistants (PDAs), portable video/music players, electronic books, electronic book readers, tablet computers, portable gaming devices, and the like. Some of such devices include the iPad (trademarked by Apple, Inc.), the iPod (trademarked by Apple, Inc.), the iPhone (trademarked by Apple, Inc.), the BlackBerry (trademarked by RIM, Inc.), the Android (trademarked by Google, Inc.), Android-based devices, and other portable devices.

It would be advantageous to provide an apparatus, method, and system that would include one or more of the features of 1) detecting (or establishing or allowing entry of) the open or close status of a garage from distances farther away than immediately near the garage entrance; 2) allowing a user to send a command to the garage opener; 3) interfacing with practically all makes and models of garage door opener systems without extensive hardware modifications; 4) sending alerts from the garage to the user; and 5) uses the communication equipment (such as portable devices) and networks that a user already uses, avoiding inconvenient changes to a user's equipment or communication network systems.

### SUMMARY OF THE INVENTION

In one aspect of the present invention, a system for the remote diagnosis and/or remote monitoring and/or remote initialization of equipment, being controlled by a microprocessor, operated by an electric motor, and monitored by sensors, said system may comprise; at least one data transmission device being configured to transmit and receive data, said data transmission device being configured to communicate with a microprocessor control unit of equipment, said data transmission device being configured to transmit data directly between a remote location and said microprocessor, and said data transmission device comprises; a portable wireless device, an interface, and said interface being configured and disposed to connect said wireless device with said microprocessor.

In another aspect of the present invention, a active monitoring system for use with an automatic garage door opener may comprise, a control unit that is in communication with an automatic garage door opener when a prescribed event occurs within a garage, a status sensor for determining the status of a garage door, an interior camera and an exterior camera that are both in communication with the control unit, and an application resident on a networked appliance for monitoring and controlling the automatic garage door opener, wherein the control unit includes a display that displays an activity log and status and journals the date and time when the garage door is opened and closed.

These and other aspects, objects, features and advantages of the present invention, are specifically set forth in, or will become apparent from, the following detailed description of an exemplary embodiment of the invention when read in conjunction with the accompanying drawings.

### BRIEF DESCRIPTION OF THE DRAWINGS

FIG. 1 is a schematic diagram of a system and information flow for a garage door opening application, according to an embodiment of the present invention; and

FIG. 2 is a flow diagram of a system and information flow, according to another embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention relates generally to remotely monitoring and controlling of equipment, such as garage door openers, sprinkler systems HVAC (heating, ventilation, and air conditioning systems), security doors, and other equipment amenable to remote monitoring and control. Although the following description may primarily discuss monitoring and controlling garage door openers, it is understood that the present invention may also be used for any equipment suitably monitored and controlled remotely.

Examples referencing smartphones, tablets, and other networked appliances should not be considered as exclusive examples. Any networked device may be used to monitor and control equipment, including systems installed on-board in vehicles, such as in the dashboard of automobiles.

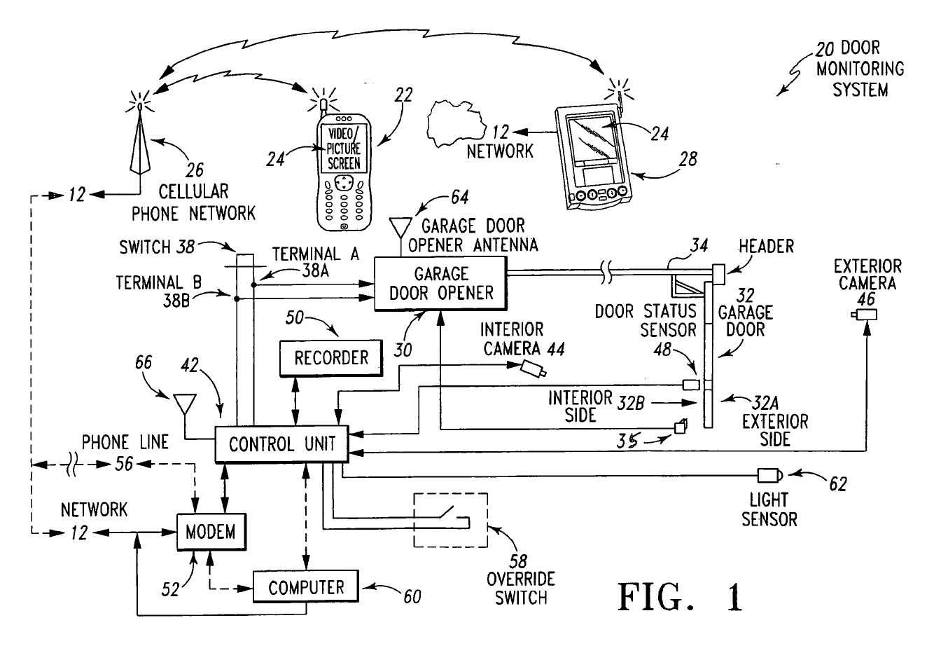

Referring now to the drawings in detail, wherein like reference characters refer to like elements, there is shown in FIG. 1 a door monitoring system 20 which advantageously permits a remote user to actuate a garage door while optionally viewing video and/or photographs of the areas near the garage door. In addition to commercial and residential door monitoring applications, it should be appreciated that similar embodiments of the door monitoring system also encompass remote control by users of doors other than garage doors. For example, the described system also comprises control of gates, windows, shutters, blinds, draperies, sky lights, pool covers, sprinkler systems, HVAC systems, portals and other similar applications. Accordingly, it will be understood that many of the descriptions herein are meant for illustrative purposes of a general safety and security monitoring system and not limited to only a garage door monitoring system.

The door monitoring system 20 may also provide a user with various features including, but not limited to, automatic notification that the door has been left open and the ability to open or close the door remotely while viewing the areas near to the interior and exterior side of the door. Other features of door monitoring system 20 include the ability to remotely request various reports on the status or activity of the entryway. For example, some embodiments of the door monitoring system 20 may allow a user to request an activity log that reports remote access requests as well as door activities during a specified period of time. Other requests may allow the user to call into the door monitoring system for a peace-of-mind check of the status of the door. Such checks may include obtaining the current status of the door, such as whether the door is open or closed. In addition, the remote command operations may allow a user to remotely actuate a door under control to allow access by a family member, friend, and/or service providers. Still other embodiments of the reporting mechanisms may allow the user to view a video and/or photographs or image of the areas near to the interior or exterior of the door being controlled. As discussed later, door monitoring system 20 may also allow a user to remotely command a door to open or close while storing a video clip and/or photographs of the areas near to the door just prior, during, and after the command is executed.

One aspect that may be incorporated into a notification feature of the door monitoring system 20 is a means for providing a remote user notification that the door is ajar via various network interfaces including, but not limited to, a telephone network, cellular telephone network, the Internet, or by any other networking method that would occur to one skilled in the art. An additional feature of the door monitoring system 20 provides for simultaneous use of different aspects of network 12 depending upon the volume and type of data to be delivered or the location of the remote user. For example, door monitoring system 20 may generate an initial call to the user via cellular telephone network 26. After successfully contacting the user, door monitoring system 20 delivers video or pictures to the remote user, such as via a high speed cable internet connection, while continuing to accept inputs over cellular phone network 26.

A notification system also may permit a user to specify in advance various preferences. For example, a user of the door monitoring system 20 may select multiple ways of notification; wherein, door monitoring system 20 prioritizes the message destination based upon a selected set of criteria. Other embodiments of the door monitoring system 20 may select the destination of the notification message based upon the time of day and/or the ambient light level detected in the areas near to the door under control. Still other embodiments of the door monitoring system 20 may selectively set the system alarm time, which corresponds to a timer alarm period parameter that a user programs. The alarm time may be a period of time between the opening of the door and the sending of the notification message.

In some embodiments, the alarm time may vary depending upon the time of day, day of the week, or the ambient light level sensed in a region or area of interest. As a non-limiting example, some embodiments of the door monitoring system 20 may select a timer alarm period based upon the day of the week and time of day; while other embodiments may select a timer alarm period based upon the ambient light detected in a region or an area of interest. Likewise, some embodiments of door monitoring system 20 provide for an immediate alert, without delay. For example, a user may enable the immediate alert feature between the hours of 10:00 am and 5:00 pm during the work week and during periods of out-of-town travel. Effectively, the alarm period parameter is set to zero during the specified time periods.

Continuing with FIG. 1, the door monitoring system 20 may interface with other networked appliances to allow a user to remotely operate a garage door opener system. For example, in some embodiments, the door monitoring system 20 may be operably coupled to network 12. Door monitoring system 20 may use network 12 to interface with a cell phone 22 having a video/picture screen 24. Cell phone 22 interfaces with a cellular phone network 26 that operably couples to a network 12. This provides a means of communication between the cell phone 22 and door monitoring system 20. Similarly, other network appliances 28, for example, smartphones, computers, laptops, tablets, Internet-based applications, browsers, browser-based systems, java applets, interface with door monitoring system 20 to allow remote control and monitoring of a door 32. One advantageous embodiment will involve “apps” such as applications available on the iPad (trademarked by Apple, Inc.), the iPod (trademarked by Apple, Inc.), the iPhone (trademarked by Apple, Inc.), the BlackBerry (trademarked by RIM, Inc.), the Android (trademarked by Google, Inc.), Android-based devices, and other portable devices, and the like. Apps, such as Intelligarage IGX smartphone apps may be integrated and enabled with in-build voice instruction functions or other voice-operated features, such as commonly used with smartphones (e.g., Siri).

Door monitoring system 20 may comprise a garage door opener 30 operably coupled by a mechanism 34 for opening and closing a garage door 32, wherein the garage door has an exterior side 32A and an interior side 32B. The garage door opener 30 may further comprise an obstruction sensor 35 operably coupled to the garage door opener 30, which prevents garage door opener 30 from closing garage door 32 when the entrance is obstructed. Additionally, garage door opener 30 may interface with switch 38 having a terminal 38A and terminal 38B. Toggling switch 38 may cause the garage door opener 30 to actuate garage door 32.

Door monitoring system 20 may further comprise a control unit 42 and a door status sensor 48. Control unit 42 may include an interface operably coupled to switch 38 that allows control unit 42 to control the garage door opener 30 to actuate garage door 32. Control unit 42 may also be operably coupled (e.g., wired or wirelessly) to an interior camera 44 and an exterior camera 46. Interior camera 44 may provide a picture or video and/or photographic image of an area near to the interior side 32B of garage door 32. Similarly, the interior camera 46 may be operably coupled (e.g., wired or wirelessly) to control unit 42, and provide a picture or video images of the exterior side 32A of garage door 32. Video and/or photographs from the interior camera 44 and exterior camera 46 may be provided to the user of a door monitoring system 20 via network 12. This allows the user to view and store images of the areas near the garage door 32 just before, during, and after a command to remotely actuate garage door 32 via garage door opener 30. The door status sensor 48 may be operably coupled to control unit 42 and provide the control unit 42 with information regarding the position of garage door 32. Examples of a door status sensor 48 include a magnetic sensor, an optical sensor, accelerometers, gyroscopes, tilt-based sensors, physical on/off based sensors, cameras, or other means known in the art for determining the relative position of a door. Likewise, it should be understood by those skilled in the art that some embodiments of door monitoring system 20 use the interior camera 44 and exterior camera 46 in place of door status sensor 48 to provide control unit 42 with the relative position of garage door 32. The control unit 42 may feature an AUTO CLOSE function that may be programmed to automatically close a door after a certain amount of time.

Other embodiments of door monitoring system 20 may comprise a recorder 50 operably coupled (e.g., wired or wirelessly) to control unit 42. Recorder 50 may be a recording device that provides a means for recording various forms of information gathered or used by door monitoring system 20 including: pictures and video and/or photographs provided by the interior camera 44 and exterior camera 46; commands entered into the door monitoring system 20; logs of door activities and remote accesses to the door monitoring system 20; system profile data, programs, user data, and any other information that may occur to one skilled in the art. Recorder 50 may comprise various methods for storing and managing information. For example, in one mode of operation, the stored information may be retained for a fixed period of time.

In yet another mode of operation recorder 50 retains the stored information for 60 days. Still another mode of operation recorder 50 deletes the stored information on a needs basis similar to a circular buffer memory; wherein, the most recent information replaces the oldest information. Other information management techniques include prioritization of the stored information; wherein the least important information is deleted first. In some embodiments, recorder 50 is a hard drive. As a non-limiting example, embodiments of recorder 50 may include: CD drives; read-write CD drives; DVD drives, floppy drives; tape recording devices; dynamic memories; static memories; or programmable memories. Likewise, some embodiments of recorder 50 comprise combinations of dynamic and programmable memory. Examples of memory types include, but are not limited to: SDRAM; RAM; DRAM; SRAM; RAM BUS; or flash memory. Additionally, other embodiments of recorder 50 may comprise programmable and/or removable memory systems. As a non-limiting example, this includes: flash drives; thumb drives; tape; flash; thumb drives; flash thumb drives; magnetic tape; optical discs; CD's; DVDs, floppies; or portable hard drives. Some embodiments of recorder 50 comprise remote storage devices or networked storage devices.

Some embodiments of door monitoring system 20 may further comprise a means for playing back and displaying the video and/or photographs, pictures, and information stored on recorder 50. For example, some embodiments include interfaces to televisions, computers, computer monitors, display units, projectors, web browsers, Java applications, printers, cell phones, PDA devices, smartphones, and other devices as may occur to those skilled in the art.

Among other features, in some embodiments, control unit 42 may comprise, for example, microprocessors, computers, microcontrollers, state machines, FPDA's, and other programmable logic devices. Some embodiments of control unit 42 may include logic units, static and dynamic memories, ROM, RAM, and flash. Likewise, control unit 42 may include interfaces to exterior memory systems: SRAM; DRAM; SDRAM; RAM BUS; flash; hard drives; CD drives; DVD drives, floppy drives; and other similar means of providing for memory access and storage. Other embodiments of control unit 42 may comprise various I/O, networking and user interfaces including touch pads, means for data entry, display, display interfaces, networking interfaces, timers, clocks, internal clocks, counters, interrupt controllers, and communication ports as would be understood by those skilled in the art.

In yet other embodiments, control unit 42 may be a PC, laptop PC, programmable calculator, programmable machine, cellular telephone, or other networked appliance. Additionally, control unit 42 may further comprise methods for tracking and updating the time of day. For example, one feature of control unit 42 allows a user to enter the local time. In another mode of operation, control unit 42 updates an internal clock by obtaining the time from a networked device; such as, downloading the time of day from a web site linked to the official local time of day or a cellular telephone network 26.

Some embodiments of control unit 42 may also include built-in peripheral interfaces. For example, control unit 42 may include an on-board modem for connecting to various network systems. Exemplary network connections include: phone lines; cellular network; cable networks; wireless networks; DSL networks; satellite systems; Ethernet networks; optical networks. It will be understood that some embodiments of network 12 comprise a telephone system. Potential network connections include interfaces to wireless, wired, or optical networks. Illustratively, control unit 42 may include network connections comprising Bluetooth™, IRDA™ IEEE 802.11(a, b, f, g). Still other embodiments of control unit 42 include interfaces to home networking systems based upon Smarthouse™, CE Bus™, and Home Bus™. Likewise, in some embodiments, control unit 42 is integrated into a home automation system.

Continuing with FIG. 1, some embodiments of door monitoring system 20 may comprise an exterior modem 52 operably coupled to control unit 42; wherein, modem 52 is operably coupled (e.g., wired or wirelessly) to network connection 12 and/or phone line 56. In addition, some embodiments of control unit 42 include an interface operably coupled (e.g., wired or wirelessly) to a computer 60. Likewise, computer 60 may be either operably coupled (e.g., wired or wirelessly) to modem 52 or directly coupled to network connection 12 (e.g., wired or wirelessly).

As a non-limiting example, an embodiment may comprise a modem 52 coupled to at least one wide area network including: telephone; cellular telephone; ATM; Ethernet; DSL; satellite; or cable. Modem 52 provides a network interface to network 12 for control unit 42 and, in some embodiments, computer 60. Control unit 42 may interface with other network appliances including, but not limited to, a cellular phone network 26, network appliance 28, or Internet connections.

In some embodiments, computer 60 is a computer or laptop computer. However, in other embodiments, computer 60 may be either a hand-held computing device, such as a PDA, cell phone, smartphone, or other networked appliance. Computer 60 may interface with control unit 42 by either a wireless or hardwired interconnection. A non-limiting example list of potential interfaces includes IR, optical, RF, serial port, and USB.

In still other embodiments, control unit 52 may be operably coupled (e.g., wired or wirelessly) to an override switch 58 having a system enable state and a system disable state. Operating override switch 58 may place the door monitoring system 20 in a system override state, which allows the user to selectively disable features of the door monitoring system 20 while not disabling other command, control and monitoring features and functions. Other status of override switch 58 may places door monitoring system 20 in a system enable state. As a non-limiting example, implementations of override switch 58 include optical, toggle, or contact switches. In some embodiments of the door monitoring system 20, the override switch 58 may be incorporated into a separate control panel (not shown), or within other control mechanisms integrated into the control unit 42, computer 60, or garage door opener 30. Software may assist in operation of the control unit 42 for establishing a soft switch as a replacement or corresponding function of an existing on/off door switch.

Some embodiments of control unit 42 are operably coupled (e.g., wired or wirelessly) to a light sensor 62. The light sensor 62 may allow the door monitoring system 20 to sense ambient light in a desired region or area. Non-limiting example embodiments of light sensor 62 may comprise photo diodes or solar cells. In still other embodiments, a camera may detect ambient light level within an area or region of interest. For example, the video and/or photographs from the exterior camera 46 may be used to sense the ambient light level on the exterior side 32A of the garage door 32. In some embodiments, control unit 42 selectively chooses between control parameters based upon the ambient level of light detected by light sensor 62.

Some embodiments of door monitoring system 20 may further comprise a garage door opener antenna 64 operably coupled (e.g., wired or wirelessly) to garage door opener 30. Likewise, some embodiments include an antenna 66 operably coupled (e.g., wired or wirelessly) to control unit 42. This may provide a means of communication between control unit 42 and garage door opener 30.

Additionally, in some embodiments, antenna 66 of control unit 42 may be used to operably couple (e.g., wired or wirelessly) the door monitoring system 20 to a cellular phone network 26. This allows the door monitoring system 20 to communicate directly with cell phone 22 or networked appliances 28.

Yet another feature of door monitoring system 20 may further include a server application. A remote user may then interface with door monitoring system 20 by logging onto a server (not shown) attached to network 12. The server acts as an interface to door monitoring system 20. The server application comprises, among other features, a user interface comprising: video and/or photographs or pictures from door monitoring system 20; command functions; and monitoring functions. The server functionality can be either in integrated into control unit 42 or a separate network device attached to network 12.

In one example the server function may run on a remote server connected to network 12. The user may contact the server by directing a web browser to a web site comprising a user interface with a login prompt. Upon logging into the server, the server provides the user with a user interface to a specified door monitoring system 20. The server also contacts the door monitoring system to be controlled and obtains relevant status information and initiates a picture or video session; wherein, video or pictures of the area or regions near the garage door are provided to the server. The server them provides the video and/or photographs and status information either directly or indirectly to the user client. For example, the server may re-transmit the received video or pictures to the user client. Alternatively, the server may configure the user client to receive the video stream or pictures (e.g., photographs) directly and the door monitoring system 20 to provide the user client the video stream or picture directly.

At least one embodiment of door monitor system 20 includes a notification feature wherein the system sends a notification message to a user at a desired notification message destination when the door is open for a specified period of time. Illustratively, the door monitoring system calls a user-specified cell phone to provide a set of notification messages and/or options.

Some embodiments of door monitoring system 20 provide a user interface that allows the user to specify a series of message destinations including prioritization parameters. The prioritization parameters allow control unit 42 to select a preferred destination for the notification message. In addition, some embodiments of door monitor system 20 allow a user to specify a variety of notification message destinations. In other embodiments a user can specify alternative destinations. A non-limiting example list of potential notification message destinations includes: cell phone numbers, telephone numbers, voice mail, voice messaging systems, pagers, email, or internet application messages. Illustratively, in at least one embodiment, control unit 42 generates a voice-based phone call to a user's cell phone 22, and provides the user with a voice message prompt. The voice message prompt informs the user that the caller is a door monitoring system and requesting that the user log onto the system. If the attempted notification is unsuccessful, the door monitoring system selects another message destination. For example, this may include sending a text message to a pager or email system, sending a video email message comprising a photograph or video clip from interior camera 44 and exterior camera 46 to a user's email address, or calling an alternative phone number.

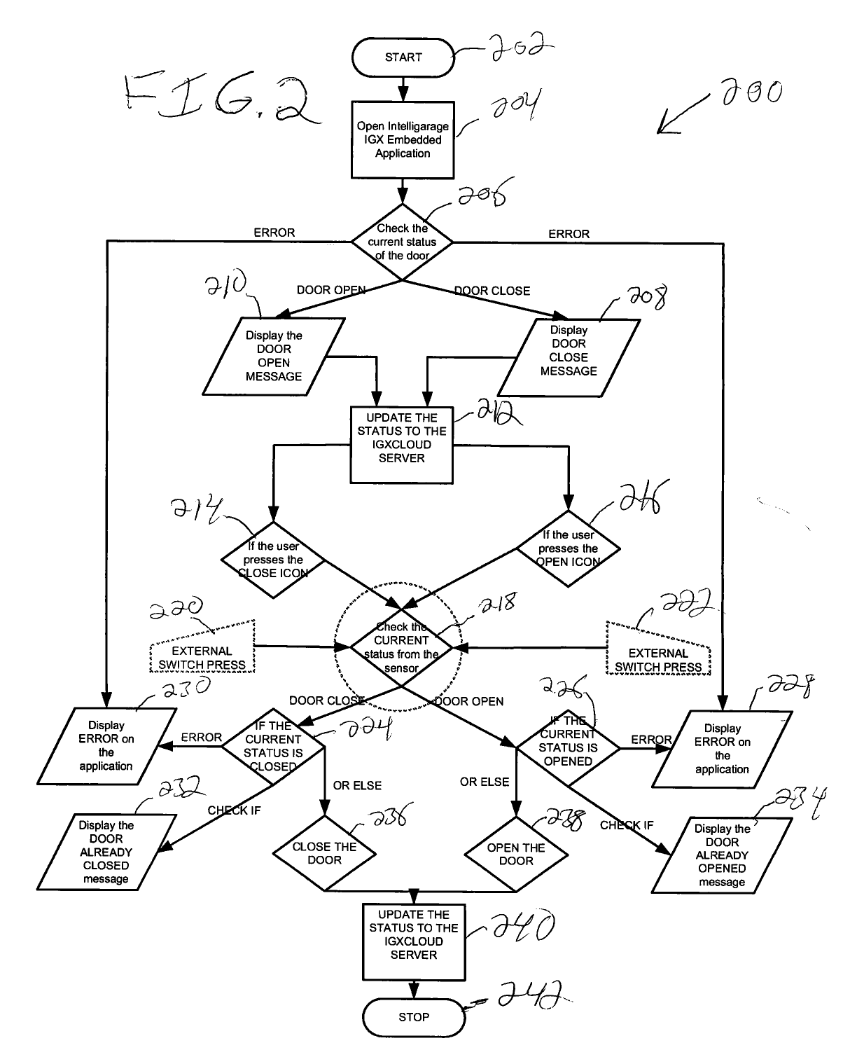

FIG. 2 shows a Garage Door Sensor Unit which acts as a sensor (such as door status sensor 48 from FIG. 1) for garage door operations. The purpose and function of this unit is to send and/or report to the Garage Door Control Unit; the status of the garage door at any given point of time. Status may be Door Open, Door Close, Door Error, Sensor Error, Sensor Communication Error, Sensor Battery related errors and/or similar features.

The Garage Door Sensor Unit may be installed with a sub sensor which checks the physical motion and status of the garage door and further report the status wirelessly to the Garage Door Control Unit. In an embodiment of the present invention, a physical spring style push button type of sensor may be used for reliable operations. The unit may also be implemented with magnetic type sub sensor units.

The system may have additional functions to check that the Garage Door Sensor Unit is in communication and within wireless range of the Garage Door Control Unit. This function may be further enhanced by adding a link tester feature to check the above said component communications. The Garage Door Sensor Unit may operate on battery power to be protected from overuse or non-use.

The sensor may be equipped with a power on-off switch in case the owner has to leave for a long time and is confident of not using the system when the user is away. The Garage Door Sensor Unit is capable of sending and communicating to the Garage Door Control Unit using various wireless technologies like 2.4 GHz, 433 MHz, Wi-Fi, Zigbee, Bluetooth, and various others.

The Garage Door Sensor Unit may use a mechanism of the “status change” in the sensor position. When the garage door is opened the garage door sensor status may also change and at that time it may send the information to the Garage Door Control Unit about status changes, such as, OPENED. When the garage door is closed, the garage door sensor status may also change and at that time it may send the information to the Garage Door Control Unit about its status changes, namely CLOSED. When the garage door is opening or closing the garage door sensor status also changes and at that time it may send the information to the Garage Door Control Unit about status changes namely OPENING or CLOSING. When the garage door is opening and closing and has issues (e.g., not fully opened or closed) the garage door sensor status (OPENING and CLOSING) also changes and at that time it may send the information to a garage door control unit about status changes, such as, ERROR in DOOR OPENING or CLOSING.

The garage door sensor may be installed on the south edge of the garage door and may be in touch with the ground as one of the functions for reporting the correct status. When the garage door sensor is touching the ground, the sensor may press and be either ON or OFF based on the internal configuration. When the garage door sensor unit leaves the ground and is in flight with the garage door, the sensor status may change and the reporting back to the garage door control unit is performed.

Continuing with the system 200 of FIG. 2, the process may start at step 202. At step 204 an IGX embedded application may be opened. A decision may be rendered at step 206 to check the status of the door. If the door is closed, then at step 208 the app may display a “door closed message.” If the door is open, a “door open message” may be displayed in step 210. At step 212 the door status may be updated, such as being updated to an IGX Cloud Server. If the app user presses the “close” icon in the user interface, then the process may proceed from step 214 to step 218. If the app user presses the “open” icon in the user interface, then the process may proceed from step 216 to step 218. Data collected by IGX cloud services my be used for business intelligence, customer support, data mining, data analytics, technical support, and other useful functions.

At step 218 the current status of the door is checked using the sensor(s), External switch presses 220, 222 may be used in step 218. If the door is sensed as “closed,” then the process may proceed to step 224 to check status, such as “error” (step 230), “or else” (step 236 “close the door”), or to further check if the message states “door already closed” (step 232). If the door is sensed as “open,” then the process may proceed to step 226 to check status, such as “error” (step 228), “or else” (step 238 “open the door”), or to further check if the message states “door already opened” (step 234). The system 200 may update status to the server at step 240 and may end at step 242.

It should be understood, of course, that the foregoing relates to exemplary embodiments of the invention and that modifications may be made without departing from the spirit and scope of the invention as set forth in the following claims. Furthermore, a method herein described may be performed in one or more sequences other than the sequence presented expressly herein.

We claim:

1. A system for the remote diagnosis and/or remote monitoring and/or remote initialization of equipment, being controlled by a microprocessor, operated by an electric motor, and monitored by sensors, said system comprising:
at least one data transmission device being configured to transmit and receive data;
said data transmission device being configured to communicate with a microprocessor control unit of equipment;
said data transmission device being configured to transmit data directly between a remote location and said microprocessor; and
said data transmission device comprises:
a portable wireless device;
an interface; and
said interface being configured and disposed to connect said wireless device with said microprocessor.

2. The system of claim 1, wherein the equipment is a garage door opener.

3. The system of claim 1, wherein the data transmission device communicates with the microprocessor control unit via one or more of MMS, SMS, text messaging, Internet, website, radio, photograph, telephone, telegraph, television, video display.

4. The system of claim 1, wherein the data transmission device communicates with the microprocessor control unit via one or more of software, an app, notification service.

5. The system of claim 1, wherein the data transmission device communicates between the remote location and the microprocessor via one or more of MMS, SMS, text messaging, Internet, website, radio, photograph, telephone, telegraph, television, video.

6. The system of claim 1, wherein the data transmission device communicates between the remote location and the microprocessor via one or more of software, an app, notification service.

7. The system of claim 1, wherein a user provides a response to an option to ignore, respond to, or block contact with an alert from the system.

8. The system of claim 1, a control unit in communication with the system, the system sending an alert when a predetermined event occurs within a building or otherwise enclosed area.

9. The system of claim 5, wherein the control unit communicates with a control unit that is in communication with an automatic garage door opener.

10. The system of claim 6, wherein the control unit transmits a control signal to the automatic garage door opener for opening and closing a garage door and transmits or receives an alert.

11. An active monitoring system for use with an automatic garage door opener comprising:
a control unit that is in communication with an automatic garage door opener when a prescribed event occurs within a garage;
a status sensor for determining the status of a garage door;
an interior camera and an exterior camera that are both in communication with the control unit; and
an application resident on a networked appliance for monitoring and controlling the automatic garage door opener;
wherein the control unit includes a display that displays an activity log and status and journals the date and time when the garage door is opened and closed.

12. The system of claim 11, wherein the control unit comprises a user interface for performing at least one operation selected from the group consisting of: scrolling the activity log, setting an alert, and changing a display configuration.

13. The system of claim 12, wherein the control unit performs at least one of the operations via a soft switch.
